(19) United States
(12) Patent Application Publication
(10) Pub. No.: US 2024/0105032 A1
(43) Pub. Date: Mar. 28, 2024

(54) MERCHANDISE DATA PROCESSING APPARATUS AND MERCHANDISE DATA PROCESSING METHOD

(71) Applicant: Toshiba Tec Kabushiki Kaisha, Tokyo (JP)

(72) Inventor: Yuji HAYASHI, Tagata Shizuoka (JP)

(21) Appl. No.: 18/349,021

(22) Filed: Jul. 7, 2023

(30) Foreign Application Priority Data
Sep. 22, 2022 (JP) 2022-151657

(51) Int. Cl. G07G 1/12; G06Q 30/06

(52) U.S. Cl. CPC G07G 1/12; G06Q 30/06

(57) ABSTRACT

In an embodiment, a merchandise registration apparatus has a processor configured to calculate a first-type value for a check digit of a merchandise code according to a first code system, and compare the first-type value to the check digit of the merchandise code according to the first code system, register an item of merchandise corresponding to the merchandise code when the first-type value matches the check digit of the merchandise code according to the first code system. If the first-type value does not match the check digit, a second-type value is calculated for the check digit according to a second code system, and the calculated second-type value is compared to the check digit according to the second code system. When the second-type value matches with the check digit in the merchandise code, the processor registers an item of merchandise corresponding to the merchandise code according to the second code system.

### CROSS-REFERENCE TO RELATED APPLICATION

This application is based upon and claims the benefit of priority from Japanese Patent Application No. 2022-151657, filed Sep. 22, 2022, the entire contents of which are incorporated herein by reference.

### FIELD

Exemplary embodiments described herein relate to a merchandise data processing apparatus and a merchandise data processing method.

### BACKGROUND

In a store, a point of sales (POS) terminal registers merchandise being purchased by a customer based on a merchandise code input via a product scanner or by manual input. Typically, the merchandise code is from one of preexisting code systems (standards) such as a Japanese article number (JAN) code or a universal product code (UPC) code. Such code systems may use codes having differing numbers of digits.

The JAN code standard has a 13-digit standard type code and an 8-digit shortened type code. Furthermore, the JAN code permits source marking and in-store marking. The source marking is the JAN code for a barcode symbol for merchandise indicating a manufacturer of the merchandise. In the JAN code for the source marking, two digits at the beginning are country codes. For example, the country code of Japan is “45” or “49”. The in-store marking is the JAN code for an independent (store dependent) barcode symbol for merchandise at a store. Since generally the JAN code for the in-store marking can be independently determined by each store (or company), the two digits at the beginning of the code are not necessarily the country codes. Therefore, in the JAN code for the in-store markings, the first digit may be “0”.

The UPC code standard includes a 13-digit UPC-A code type, an 8-digit UPC-E code type, and the like. In the UPC-E code, a first digit is “0”.

The JAN code and the UPC-E code of the shortened type of the in-store marking are both 8-digit codes, but require different calculation methods for a check digit. When the POS terminal calculates a check digit by a calculation method corresponding to a code system different from the actual code system of the merchandise code, the check digit obtained by the calculation usually will not coincide with a check digit included in the merchandise code. In such a case, the POS terminal processes the input merchandise code as an error (due to the faulty check digit calculation) and does not register the merchandise.

### BRIEF DESCRIPTION OF THE DRAWINGS

FIG. 1 is a block diagram of a POS terminal according to an embodiment.

FIG. 2 is a flowchart of a procedure of merchandise registration performed by a processor.

FIG. 3 is a flowchart of a procedure of condition determination performed by a processor.

### DETAILED DESCRIPTION

In general, according to one embodiment, a technique that can reduce errors in the reading of merchandise codes is provided.

According to one embodiment, a merchandise registration apparatus includes a processor configured to: receive an input of a merchandise code; calculate a first-type value for a check digit of the merchandise code according a first code system; compare the calculated first-type value to a value of the check digit of the merchandise code according to the first code system; register an item of merchandise corresponding to the merchandise code according to the first code system when the first-type value matches the value of the check digit of the merchandise code according to the first code system; calculate a second-type value for the check digit of the merchandise code according to a second code system if the first-type value does not match the check digit of the merchandise code; compare the calculated second-type value to the value of the check digit for the merchandise code according to the second code system; and register an item of merchandise corresponding to the merchandise code according to the second code system when the second-type value matches the check digit in the merchandise code.

### Embodiment

Hereinafter, an example embodiment will be described with reference to the drawings. In each drawing, the same constituent elements are denoted by the same reference symbols, and repeated description of such aspects may be omitted.

### Configuration Example

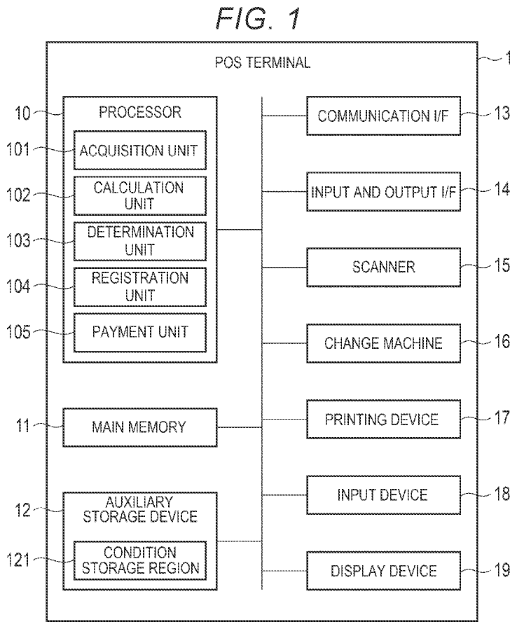

FIG. 1 is a block diagram exemplifying a POS terminal 1 according to the embodiment.

The POS terminal 1 is an electronic apparatus that implements merchandise registration and payment processing. The merchandise registration is a process of registering merchandise for a sales transaction. Here, the transaction is a commercial transaction involving the transfer of merchandise between a customer and a store. The payment processing is the processing required for settlement of the transaction (e.g., the payment of the price of the goods sold in the transaction). The POS terminal 1 is an example of a registration apparatus that implements at least merchandise registration. The POS terminal 1 is also an example of a merchandise data processing apparatus that can process merchandise data even if not specifically involved in a sales transaction. For example, the merchandise data in this context is a merchandise code.

The merchandise code is a code that can uniquely identify either a particular item of merchandise or a type of merchandise. The merchandise code is a multi-digit numeric string. The leftmost digit in the numeric string is referred to as a leading digit in the numeric string. The leading digit is also called a first digit. The rightmost digit in the numeric string is also referred to as a last digit in the numeric string. When the merchandise code has eight digits in total, the last digit in the numeric string is the eighth digit. The merchandise code can have various numbers of total digits corresponding to various established code systems such as a JAN code or a UPC code. The merchandise code usually includes a check digit as the last digit. The check digit is a number permitting the checking of whether there is an error in the reading of the numeric string corresponding to the merchandise code.

Here, an 8-digit merchandise code will be described as an example by using the JAN code and a UPC-E code of a shortened type for in-store markings. In the following description, the JAN code of the shortened type is referred to as an 8-digit JAN code. The 8-digit JAN code and the UPC-E code for the in-store marking are both 8-digit codes. When the merchandise code is the 8-digit JAN code, the first digit of the merchandise code may be “0”. When the merchandise code is the UPC-E code, the first digit of the merchandise code is “0”. A method for calculating (evaluating) the check digit differs between the 8-digit JAN code and the UPC-E code.

Either one of the 8-digit JAN code and of the UPC-E code can be considered a first code system, with the other being considered a second code system. More generally, the first code system and the second code system are code systems having the same number of digits, but with differing standard methods for calculating the check digit value. A check digit obtained by calculation based on the calculation method of the first code system is referred to as a first-type check digit. The first-type check digit for a merchandise code corresponding to the first code system may be more simply referred to as a first check digit. A check digit obtained by calculation based on the calculation method of the second code system is also referred to as a second-type check digit. The second-type check digit for the merchandise code corresponding to the second code system may be more simply referred to as a second check digit.

When the 8-digit JAN code is the first code system, the UPC-E code is the second code system. A check digit obtained by calculation based on the 8-digit JAN code is thus an example of a first check digit. A check digit obtained by calculation based on the UPC-E code is thus an example of a second check digit.

When the UPC-E code is the first code system, the 8-digit JAN code is the second code system. A check digit obtained by the calculation based on the UPC-E code is thus an example of a first check digit in this context. A check digit obtained by the calculation based the 8-digit JAN code is thus an example of a second check digit in this context.

The POS terminal 1 includes a processor 10, a main memory 11, an auxiliary storage device 12, a communication interface 13, an input and output interface 14, a scanner 15, a change machine 16, a printing device 17, an input device 18, and a display device 19. Parts that constitute the POS terminal 1 are connected so as to be able to send and receive signals to and from one another. In FIG. 1, an interface is labeled as “I/F”.

For example, the processor 10 is a central processing unit (CPU), but is not limited thereto. The processor 10 may be implemented with various dedicated circuits or other processor types. The processor 10 is an example of a processing circuit of the POS terminal 1. The processor 10 loads a program stored in advance in the main memory 11 or the auxiliary storage device 12. The program causes the processor 10 to execute processes providing functions as described later. The processor 10 can execute various processes by executing the instructions of the program.

The main memory 11 includes a nonvolatile memory region and a volatile memory region. The main memory 11 can store an operating system or a program in the nonvolatile memory region. The main memory 11 uses the volatile memory region as a work area in which data is appropriately rewritten by the processor 10. For example, the main memory 11 includes a read only memory (ROM) as the nonvolatile memory region. For example, the main memory 11 includes a random access memory (RAM) as the volatile memory region. The main memory 11 is an example of the storage unit of the POS terminal 1.

The auxiliary storage device 12 can be an electric erasable programmable read-only memory (EEPROM), a hard disc drive (HDD), a solid-state drive (SSD), or the like. The auxiliary storage device 12 can store the above-described program, data used by the processor 10 in performing various processes, and data generated by the processor 10. The auxiliary storage device 12 is an example of the storage unit of the POS terminal 1.

The auxiliary storage device 12 can include a condition storage region 121. The condition storage region 121 can store information indicating a condition for calculating a second-type check digit after calculating a first-type check digit. A reason why the second-type check digit is calculated after calculating the first-type check digit is that the code system being used for the read merchandise code may be the second code system instead of the first code system. The condition can also be referred to as a condition for handling the merchandise code by the second code system when handling the merchandise code by the first code system produces an error.

The condition may be related to an input mode. In this context, the input mode relates to method or manner the merchandise code was input. The possible input modes include a manual input of the merchandise code via the input device 18 or an input of the merchandise code via the scanner 15.

When the input mode is manual input via the input device 18, the input mode may satisfy a condition related to the input mode. When the input mode is via the scanner 15, the input mode does not satisfy the condition related to the input mode.

A reason why the input mode may matter in this context is as follows. If the input mode is manual input via the input device 18, the code system initially applied to the merchandise code may be set. When the merchandise code has eight digits, the code system initially applied is the code system of the 8-digit JAN code or the code system of the UPC-E code. However, the code system may be different from the code system initially applied to the merchandise code.

A case where the code system initially applied is the code system of the 8-digit JAN code will be described. When the merchandise code uses the code system of the 8-digit JAN code, the first-type check digit will coincide with the check digit included in the merchandise code. However, if the merchandise code does not use the code system of the 8-digit JAN code, the first-type check digit will not usually coincide with the check digit included in the merchandise code. A reason for the noncoincidence may be an input error by the operator when manually inputting the merchandise code, or it may be that the merchandise code uses the code system of the UPC-E code. When the merchandise code uses the code system of the UPC-E code, the second-type check digit will coincide with the check digit included in the merchandise code.

A case where the code system initially applied to the merchandise code is the code system of the UPC-E code will be described. When the merchandise code uses the code system of the UPC-E code, the first-type check digit coincides with a check digit included in the merchandise code. When the merchandise code does not use the code system of the UPC-E code, the first-type check digit usually will not coincide with the check digit included in the merchandise code. A reason for the noncoincidence may be an operator input error or may be that the merchandise code uses the code system of the 8-digit JAN code. When the merchandise code uses the code system of the 8-digit JAN code, the second-type check digit coincides with the check digit included in the merchandise code.

A code system switch condition may be related to the numeric string and concern how the numeric string of the merchandise code is arranged.

In an example, the numeric string is a predetermined number of digits long, and a value of a particular digit in the merchandise code is a predetermined value. For example, the predetermined number of digits can be eight, the particular digit is the first digit, and the predetermined value is “0”, but the exemplary embodiment is not limited thereto. The predetermined number of digits, the particular digit, and the predetermined value can be appropriately set according to the two target code systems.

In the example, when the number of digits of the merchandise code is equal to the predetermined number of digits and the value of the particular digit is the predetermined value, the numeric string satisfies a code setting condition related to the numeric string. When the number of digits of the merchandise code is not equal to the predetermined number of digits, the numeric string does not satisfy the condition. Likewise, when the value of the particular digit of the merchandise code is not the predetermined value, the numeric string does not satisfy the condition.

When the number of digits of the merchandise code is the predetermined number of digits and the value of the particular digit of the merchandise code is the predetermined value, the merchandise code may still be one of a plurality of different code systems having the same number of total digits. For example, when the number of digits of the merchandise code is eight and a value of a first digit of the merchandise code is “0”, the merchandise code may still be either one of the 8-digit JAN code and the UPC-E code for in-store marking.

In another example, the number of digits after the first digit of the merchandise code has been excluded may not be a predetermined number of digits but the code after the first digit can be within in a predetermined range. For example, the predetermined number of digits can be eight and the predetermined range is greater than 1000000 but less than 9999999 or less, but the exemplary embodiments are not limited thereto. The predetermined number of digits and the predetermined range can be appropriately set according to the two target code systems.

In the example, when the number of digits left after the first digit of the merchandise code has been excluded is not equal to a predetermined number of digits and the code after the first digit is within a predetermined range, the numeric string satisfies the condition related to the numeric string. If not, the numeric string does not satisfy the condition related to the numeric string.

The merchandise code may use a plurality of different code systems having the same number of digits. For example, when the number of digits after the first digit of the merchandise code is excluded is not eight and the code in seven digits after the first digit is included in a range of 1000000 or more and 9999999 or less, the merchandise codes may be the 8-digit JAN code or the UPC-E code.

In an example, when the input mode satisfies a condition and the numeric string satisfies another condition, the merchandise code satisfies the condition for a code switch. If the input mode does not satisfy the condition related to the input mode, the merchandise code does not satisfy the condition for a code switch. Likewise, if the numeric string does not satisfy the other condition related to the numeric string, the merchandise code does not satisfy the condition for a code switch.

A case where a switch condition includes a condition related to the input mode but does not include any condition related to the numeric string will be described. When the input mode satisfies the switch condition, the merchandise code satisfies the switch condition. When the input mode does not satisfy the switch condition, the merchandise code does not satisfy the switch condition.

A case where a switch condition includes a condition related to the numeric string but does not include a condition related to the input mode will be described. When the numeric string satisfies the switch condition related to the numeric string, the merchandise code satisfies the switch condition. When the numeric string does not satisfy the switch condition related to the numeric string, the merchandise code does not satisfy the switch condition.

When the merchandise code satisfies a switch condition, the processor 10 calculates the second-type check digit after first calculating the first-type check digit. When the merchandise code does not satisfy a switch condition, the processor 10 does not calculate the second-type check digit after calculating the first check digit.

The communication interface 13 includes various interfaces that can communicably connect the POS terminal 1 to another electronic apparatus via a network according to a communication protocol. The communication interface 13 is an example of a communication unit of the POS terminal 1.

The input and output (I/O) interface 14 includes various interfaces that can communicably connect the POS terminal 1 to another electronic apparatus by direct wired or wireless connection. For example, the input and output interface 14 connects the POS terminal 1 to a card reader. The card reader is a device that reads card data recorded on a magnetic stripe or an integrated circuit (IC) chip of a card medium. The card medium may include a credit card.

The scanner 15 is a device that reads various code symbols and acquires data from the code symbols. The scanner 15 may include a scanner of a type using an imaging element such as a charge-coupled device (CCD), or may include a scanner of a laser type. For example, the code symbol is a barcode symbol or a two-dimensional code symbol. The code symbol may encode a merchandise code correlated with particular items or types of merchandise. The code symbol is attached to the merchandise (for example, printed on a product container or affixed as a printed label or the like). A code symbol may encode a member code for a store loyalty program or the like. The code symbol of the member code may be on a member card or displayed on a terminal (e.g., a smartphone) display screen. The scanner 15 is an example of an input unit for inputting data to the POS terminal 1.

The change machine 16 is a device that dispenses bills or coins corresponding to a change amount due in a transaction or the like.

The printing device 17 prints a receipt or the like. For example, the printing device 17 is a thermal printer, an inkjet printer, or the like.

The input device 18 is a device that can receive an instruction (user instruction) for the POS terminal 1. For example, the input device 18 may be or include a keyboard. The input device 18 may include a touch screen implemented together with the display device 19. The input device 18 is an example of an input unit for providing data to the POS terminal 1.

The display device 19 can display various images under control of the processor 10. For example, the display device 19 is a liquid crystal display, an electroluminescence (EL) display, or the like. The display device 19 is an example of a display unit of the POS terminal 1.

The possible hardware configurations of the POS terminal 1 are not limited to the above-described configuration. Various described elements can be omitted and/or changed, and other elements can be added as appropriate.

Functions implemented by the processor 10 will be described.

The processor 10 provides the functions of an acquisition unit 101, a calculation unit 102, a determination unit 103, a registration unit 104, and a payment unit 105. The units implemented by the processor 10 can also be considered as being implemented by a control means or a control unit incorporating the processor 10 and the main memory 11.

The acquisition unit 101 acquires the merchandise code input via the input device 18 or the scanner 15.

The calculation unit 102 obtains the check digit by a calculation based on the merchandise code.

The determination unit 103 executes various determination processes.

The registration unit 104 registers merchandise by merchandise code.

The payment unit 105 processes payments for a transaction based on registration of the merchandise in the transaction.

### Operational Example

An operational example of the POS terminal 1 configured as described above will be described.

A process procedure described below is merely an example, and each described process may be changed or varied. Furthermore, certain acts or process can be omitted, replaced, modified, and/or added as appropriate.

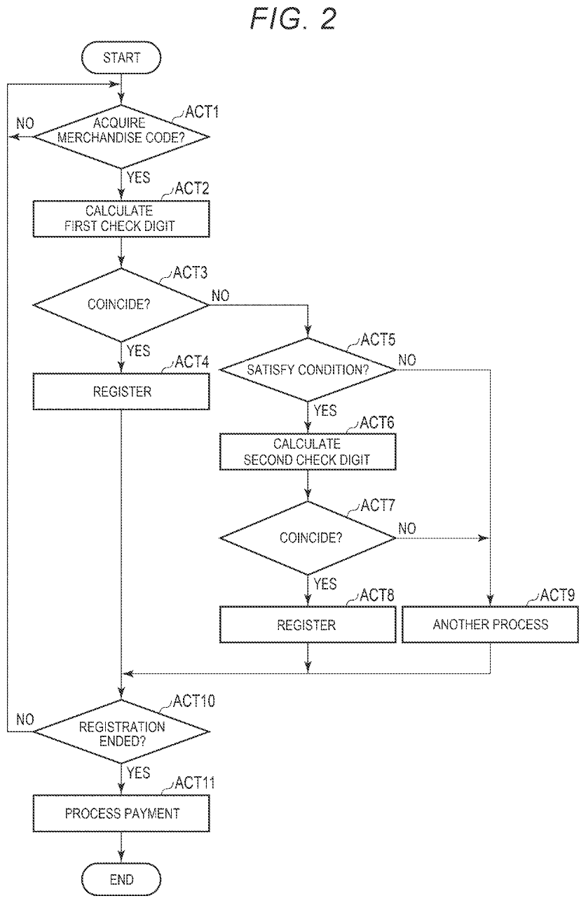

FIG. 2 is a flowchart of a procedure of merchandise registration performed by the processor 10 of the POS terminal 1.

The acquisition unit 101 acquires a merchandise code input via the input device 18 or the scanner 15 (ACT 1). When a salesclerk manually inputs a merchandise code by using the input device 18, the acquisition unit 101 acquires the merchandise code input via the input device 18. When the scanner 15 reads a code symbol attached to merchandise, the acquisition unit 101 acquires the merchandise code input via the scanner 15. When the acquisition unit 101 does not acquire a merchandise code (NO in ACT 1), the acquisition unit 101 returns to the start of ACT 1. When the acquisition unit 101 acquires a merchandise code (YES in ACT 1), the process shifts from ACT 1 to ACT 2.

Based on the acquisition of the merchandise code performed by the acquisition unit 101, the calculation unit 102 then calculates the first-type check digit for the merchandise code corresponding to the first code system (ACT 2). In ACT 2, the calculation unit 102 handles the merchandise code as an 8-digit JAN code or a UPC-E code as the first code system. The first code system may be as the code system to be tried first or may the code system set according to arrangement of a 2-digit number at the beginning of the acquired merchandise code.

The determination unit 103 determines whether the first-type check digit obtained by the calculation unit 102 coincides with the check digit included in the merchandise code (ACT 3). When the first-type check digit coincides with the check digit included in the merchandise code (YES in ACT 3), the process shifts from ACT 3 to ACT 4. When the first-type check digit does not coincide with the check digit included in the merchandise code (NO in ACT 3), the process shifts from ACT 3 to ACT 5.

When the first-type check digit coincides with the check digit included in the merchandise code, the registration unit 104 registers the merchandise correlated to the merchandise code (ACT 4). In ACT 4, for example, the registration unit 104 registers the merchandise by storing merchandise information in the main memory 21 or the auxiliary storage device 22. For example, the merchandise information includes information such as a price and a product name. The registration unit 104 may acquire the merchandise information from the auxiliary storage device 22. The registration unit 104 may acquire the merchandise information via the network from an electronic apparatus outside the POS terminal 1.

When the first-type check digit does not coincide with the check digit included in the merchandise code, the determination unit 103 next determines whether the merchandise code satisfies some code switch condition (ACT 5). When the merchandise code satisfies the code switch condition (YES in ACT 5), the process shifts from ACT 5 to ACT 6. When the merchandise code does not satisfy the code switch condition (NO in ACT 5), the process shifts from ACT 5 to ACT 9.

When the first-type check digit does not coincide with the check digit included in the merchandise code and the code switch condition is satisfied, the calculation unit 102 calculates the second-type check digit of the merchandise code corresponding to the second code system (ACT 6). In ACT 6, the calculation unit 102 treats the merchandise code as whichever of the 8-digit JAN code or the UPC-E code is considered the second code system. When the 8-digit JAN code is the first code system, the UPC-E code is the second code system (and vice versa).

The determination unit 103 then determines whether the second-type check digit obtained by the calculation performed by the calculation unit 102 coincides with the check digit included in the merchandise code (ACT 7). When the second-type check digit coincides with the check digit included in the merchandise code (YES in ACT 7), the process shifts from ACT 7 to ACT 8. When the second-type check digit does not coincide with the check digit included in the merchandise code (NO in ACT 7), the process shifts from ACT 7 to ACT 9.

When the second-type check digit coincides with the check digit included in the merchandise code, the registration unit 104 registers the merchandise correlated to the merchandise code (ACT 8). The processing of ACT 8 is generally similar to the processing of ACT 4.

When the second-type check digit does not coincide with the check digit included in the merchandise code, the processor 10 executes another process different from the merchandise registration (ACT 9). For example, in ACT 9, the processor 10 determines that the input merchandise code is erroneous, and processes the input merchandise code as an error without registering the merchandise. The processor 10 may cause the display device 19 to display an image indicating the error associated with the input merchandise code. The processor 10 may cause a sound alert to be output from a speaker or the like.

The determination unit 103 also determines whether registration of merchandise in the transaction has been ended (ACT 10). In ACT 10, for example, when the user of the POS terminal 1 presses a subtotal key by using the input device 18, the determination unit 103 determines that the registration of the merchandise in the transaction has ended. The subtotal key is a key for inputting an instruction to end of the registration of the merchandise in the transaction in order to calculate a billing amount due in the transaction. Pressing the subtotal key is an example of inputting the instruction to end of the registration of the merchandise. When the registration of the merchandise is ended (YES in ACT 10), the process shifts from ACT 10 to ACT 11. When the registration of the merchandise is not yet ended (NO in ACT 10), the process shifts from ACT 10 to ACT 1.

The payment unit 105 processes payment for the transaction based on the registration of the merchandise (ACT 11). In ACT 11, for example, the payment unit 105 processes the payment according to a selected payment method. The payment method can be an off-line payment or an on-line payment. An off-line payment is a settlement method in which the POS terminal 1 does not need to cooperate with another electronic apparatus via the network such as the Internet. For example, an off-line payment is payment by cash. An on-line payment is a settlement method executed by the POS terminal 1 in cooperation with another electronic apparatus via the network such as the Internet. For example, an on-line payment is as credit card settlement, electronic money settlement, debit card settlement, or code (voucher) settlement.

In some examples, processor 10 may omit the process of ACT 5. For example, the determination unit 103 does not determine whether the merchandise code satisfies any code switch condition. When the first-type check digit does not coincide with the check digit included in the merchandise code, the calculation unit 102 simply calculates the second-type check digit for the merchandise code.

An example of whether the merchandise code satisfies a code switch condition as performed by the determination unit 103 in ACT 5 described above will be described.

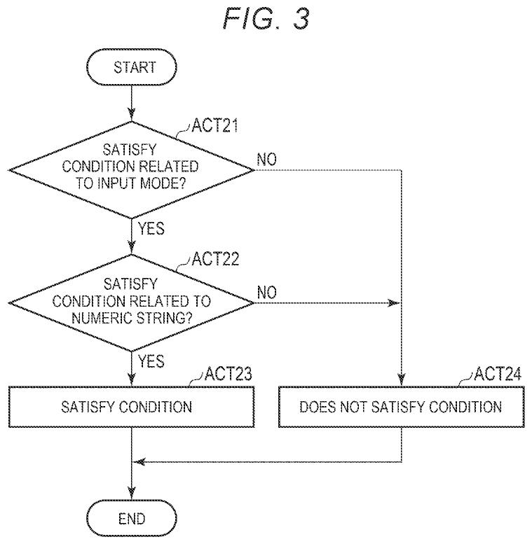

FIG. 3 is a flowchart of a procedure of a condition determination performed by the processor 10 of the POS terminal 1.

In this example, the code switch condition includes both a condition related to the input mode and a condition related to the numeric string.

The determination unit 103 determines whether the input mode satisfies the condition related to the input mode (ACT 21). When the input mode satisfies the condition related to the input mode (YES in ACT 21), the process shifts from ACT 21 to ACT 22. When the input mode does not satisfy the condition related to the input mode (NO in ACT 21), the process shifts from ACT 21 to ACT 24.

The determination unit 103 determines whether the numeric string satisfies the condition related to the numeric string (ACT 22). When the numeric string satisfies the condition related to the numeric string (YES in ACT 22), the process shifts from ACT 22 to ACT 23. When the numeric string does not satisfy the condition related to the numeric string (NO in ACT 22), the process shifts from ACT 22 to ACT 24.

When the input mode satisfies the condition related to the input mode and the numeric string also satisfies the condition related to the numeric string, the determination unit 103 determines that the merchandise code satisfies the code switch condition (ACT 23).

When the input mode does not satisfy the condition related to the input mode, or the numeric string does not satisfy the condition related to the numeric string, the determination unit 103 determines that the merchandise code does not satisfy the code switch condition (ACT 24).

When the code switch condition includes just the condition related to the input mode, the determination unit 103 omits the process of ACT 22. In ACT 23, when the input mode satisfies the condition related to the input mode, the determination unit 103 determines that the merchandise code satisfies the code switch condition.

When the code switch condition includes just the condition related to the numeric string, the determination unit 103 omits the process of ACT 21. In ACT 23, when the numeric string satisfies the condition related to the numeric string, the determination unit 103 determines that the merchandise code satisfies the code switch condition.

### (Effects)

A merchandise data processing apparatus according to an embodiment includes the acquisition unit that acquires the merchandise code input via the input unit. The merchandise data processing apparatus includes the calculation unit that calculates the first check digit of the merchandise code corresponding to the first code system, and that calculates the second check digit of the merchandise code corresponding to the second code system when the first check digit does not coincide with the check digit included in the merchandise code. The merchandise data processing apparatus includes the registration unit that registers the merchandise correlated with the merchandise code when the second check digit coincides with the check digit included in the merchandise code.

Since various code systems exist, a merchandise code may be erroneously handled by the first code system, may be correctly handled by the second code system. The merchandise data processing apparatus can increase a possibility of correctly handling a merchandise code by checking the check digit of the merchandise code as calculated in different code systems. Accordingly, the merchandise data processing apparatus can reduce a possibility of determining that the input merchandise code is erroneous, and can reduce the errors in the input of merchandise codes. The merchandise data processing apparatus can reduce a work load of a user who registers merchandise.

In the merchandise data processing apparatus according to an embodiment, the first code system and the second code system are code systems having the same number of digits but different calculation methods for the check digit.

Like with the 8-digit JAN code and the UPC-E code, even though the number of digits is the same, the code systems calculate the check digit differently.

In the merchandise data processing apparatus according to an embodiment, when the first-type check digit does not coincide with the check digit included in the merchandise code and the merchandise code satisfies a code switch condition, the calculation unit calculates the second-type check digit.

The merchandise data processing apparatus can change whether to attempt to calculate the second-type check digit according to whether the merchandise code as read or input satisfies certain conditions. Thus, when there is considered a high possibility that a merchandise code erroneously handled by the first code system will be correctly handled by the second code system, the merchandise data processing apparatus can calculate the second-type check digit. Since the merchandise data processing apparatus calculates the second-type check digit only when success is considered to be high, a processor load or the like can be reduced since unlikely attempts are avoided.

In the merchandise data processing apparatus according to an embodiment, a code switch condition may relate to the number of digits in the merchandise code and the value of a particular digit (e.g., the first digit) in the merchandise code.

For example, in both the 8-digit JAN code and the UPC-E code for in-store marking, the number of digits in the merchandise code are the same, and the value of the first digit of the merchandise code can be the same. Thus, even if the merchandise code is erroneously handled by one code system, the merchandise code may likely be correctly handled by the other code system. The merchandise data processing apparatus can increase the possibility of correctly handling a merchandise code by checking the check digit of the merchandise code in a plurality of different code systems.

In the merchandise data processing apparatus according to an embodiment, the code switch condition relates to the digits after the first digit of the merchandise code being inside a predetermined range.

For example, in both the 8-digit JAN code and the UPC-E code, the digits after the first digit of the merchandise code can be within a predetermined range. Thus, in view of such similarities, if the merchandise code is erroneously handled by one system, it may be correctly handled by the other.

### Other Embodiments

In the an embodiment, the calculation unit 102 calculates the second-type check digit if the first-type check digit does not coincide with the check digit included in the merchandise code, but embodiments are not limited thereto. The calculation unit 102 may calculate both the first-type check digit and also the second-type check digit based on the acquisition of the merchandise code by the acquisition unit 101. In an example, when either the first-type check digit or the second-type check digit coincides with the check digit included in the merchandise code, the registration unit 104 registers the merchandise correlated with the merchandise code accordingly.

The calculation unit 102 may change the processing according to whether the merchandise code acquired by the acquisition unit 101 satisfies some condition. In an example, when the merchandise code satisfies a condition, the calculation unit 102 calculates both the first-type check digit and the second-type check digit. When the either first-type check digit or the second-type check digit coincides with the check digit included in the merchandise code, the registration unit 104 registers the merchandise correlated with the merchandise code accordingly. When the merchandise code does not satisfy the condition, the calculation unit 102 may calculate just the first-type check digit.

In an embodiment, the POS terminal 1 is used by a salesclerk, but the merchandise data processing apparatus is not limited thereto. A merchandise data processing apparatus may be an electronic apparatus for implementing only or just the merchandise registration. That is, the merchandise data processing apparatus may be a semi-self-service checkout electronic apparatus. In such an example, the merchandise data processing apparatus implements the merchandise registration, but another electronic apparatus different from the merchandise data processing apparatus implements the payment processing.

In other examples, a merchandise data processing apparatus may be a full-self-service checkout electronic apparatus. In such an example, the merchandise data processing apparatus is an electronic apparatus that is used by the customer and for both merchandise registration and payment.

In still other examples, the merchandise data processing apparatus may be a so-called cart POS that is a cart-mounted self-service registration device or a smartphone-type self-registration device executing a shopping application or the like.

In an embodiment, the 8-digit merchandise code is a JAN code or an UPC-E code of the shortened type for in-store marking, but embodiments are not limited thereto. When there are plurality of different code systems having the same number of digits, an embodiment can be similarly applied to any of the merchandise code systems having the number of digits or the like. Likewise, the number of digits in the merchandise codes of concern can be a number other than eight.

In an embodiment, the merchandise data processing apparatus is implemented as one electronic apparatus, but, in other examples, the merchandise data processing apparatus may be implemented by a system in which functions are distributed across a plurality of electronic apparatuses.

An embodiment includes a method executed by the electronic apparatus corresponding in operation to the above-described procedures of the POS terminal 1. Similarly, an embodiment includes a software program or the like including instructions to cause an electronic apparatus to execute the described functions of POS terminal 1.

Such a program may be incorporated in an electronic apparatus, or may be transferred separately from an electronic apparatus. In the latter case, the program may be transferred via a network, or may be recorded in a non-transitory, computer-readable recording medium. In general, such a recording medium may be any medium that can store a program and that can be read by the electronic apparatus such as a CD-ROM or a memory card, and a form and format thereof is not limited.

While certain embodiments are described, these embodiments are presented by way of example only, and are not intended to limit the scope of the exemplary embodiments. These novel embodiments can be implemented in various other forms, and various omissions, substitutions, and changes can be made without departing from the spirit of the exemplary embodiments. The accompanying claims and their equivalents are intended to cover such forms or modifications as would fall within the scope and spirit of the exemplary embodiments.

What is claimed is:

1. A merchandise registration apparatus, comprising:
a processor configured to:
receive an input of a merchandise code;
calculate a first-type value for a check digit of the merchandise code according to a first code system;
compare the calculated first-type value to a value of the check digit of the merchandise code according to the first code system;
register an item of merchandise corresponding to the merchandise code according to the first code system when the first-type value matches the value of the check digit of the merchandise code according to the first code system;
calculate a second-type value for the check digit of the merchandise code according to a second code system if the first-type value does not match the check digit of the merchandise code;
compare the calculated second-type value to the value of the check digit for the merchandise code according to the second code system; and
register an item of merchandise corresponding to the merchandise code according to the second code system when the second-type value matches the check digit in the merchandise code.

2. The merchandise registration apparatus according to claim 1, wherein merchandise codes according to the first code system and the second code system both have the same number of digits.

3. The merchandise registration apparatus according to claim 2, wherein calculation of the first-type value requires a calculation method different from calculation of the second-type value.

4. The merchandise registration apparatus according to claim 1, wherein calculation of the first-type value requires a calculation method different from calculation of the second-type value.

5. The merchandise registration apparatus according to claim 1, wherein the processor is configured to calculate the second-type check digit only if the first-type value does not match the check digit of the merchandise code and the merchandise code satisfies an additional condition.

6. The merchandise registration apparatus according to claim 5, wherein the additional condition is that the number of digits in the merchandise code is equal to a predetermined number and a particular digit in the merchandise code has a predetermined value.

7. The merchandise registration apparatus according to claim 5, wherein the additional condition is the digits in the merchandise code after the first digit form a code value that is within a predetermined range.

8. The merchandise registration apparatus according to claim 1, further comprising:
a product scanner for reading the merchandise code and providing the input of the merchandise code.

9. The merchandise registration apparatus according to claim 8, further comprising:
an input device for a manual input of the merchandise code.

10. The merchandise registration apparatus according to claim 9, wherein the processor is configured to calculate the second-type check digit only if the first-type value does not match the check digit of the merchandise code and the merchandise code was manually input via the input device.

11. A merchandise registration method comprising:
receiving an input of a merchandise code;
calculating a first-type value for a check digit of the merchandise code according to a first code system;
comparing the calculated first-type value to a value of the check digit of the merchandise code according to the first code system;
registering an item of merchandise corresponding to the merchandise code according to the first code system when the first-type value matches the value of the check digit of the merchandise code according to the first code system;
calculating a second-type value for the check digit of the merchandise code according to a second code system if the first-type value does not match the check digit of the merchandise code;
comparing the calculated second-type value to the value of the check digit for the merchandise code according to the second code system; and
registering an item of merchandise corresponding to the merchandise code according to the second code system when the second-type value matches the check digit in the merchandise code.

12. The merchandise registration method according to claim 11, wherein merchandise codes according to the first code system and the second code system both have the same number of digits.

13. The merchandise registration method according to claim 12, wherein calculation of the first-type value requires a calculation method different from calculation of the second-type value.

14. The merchandise registration method according to claim 11, wherein calculation of the first-type value requires a calculation method different from calculation of the second-type value.

15. The merchandise registration method according to claim 11, wherein the second-type check digit is calculated only if the first-type value does not match the check digit of the merchandise code and the merchandise code satisfies an additional condition.

16. The merchandise registration method according to claim 15, wherein the additional condition is that the number of digits in the merchandise code is equal to a predetermined number and a particular digit in the merchandise code has a predetermined value.

17. The merchandise registration method according to claim 15, wherein the additional condition is the digits in the merchandise code after the first digit form a code value that is within a predetermined range.

18. The merchandise registration method according to claim 15, wherein the additional condition is the merchandise code was manually input via an input device.

19. A non-transitory, computer-readable medium storing program instructions which when executed by a merchandise registration apparatus cause the apparatus to perform a method comprising:
receiving an input of a merchandise code;
calculating a first-type value for a check digit of the merchandise code according to a first code system;
comparing the calculated first-type value to a value of the check digit of the merchandise code according to the first code system;
registering an item of merchandise corresponding to the merchandise code according to the first code system when the first-type value matches the value of the check digit of the merchandise code according to the first code system;
calculating a second-type value for the check digit of the merchandise code according to a second code system if the first-type value does not match the check digit of the merchandise code;
comparing the calculated second-type value to the value of the check digit for the merchandise code according to the second code system; and
registering an item of merchandise corresponding to the merchandise code according to the second code system when the second-type value matches the check digit in the merchandise code.

20. The medium according to claim 19, wherein merchandise codes according to the first code system and the second code system both have the same number of digits.
